(19) United States
(12) Patent Application Publication
(10) Pub. No.: US 2024/0017504 A1
(43) Pub. Date: Jan. 18, 2024

(54) COMPOSITE PART MANUFACTURING METHOD

(71) Applicant: Airbus Operations S.L., GETAFE (ES)

(72) Inventors: Asuncion CARRASCAL IGLESIAS, GETAFE (ES); Yolanda MIGUEZ CHARINES, GETAFE (ES); Irene DÍAZ RABOSO, GETAFE (ES); Irache DE BENITO NAVARRO, GETAFE (ES)

(21) Appl. No.: 18/350,918

(22) Filed: Jul. 12, 2023

(30) Foreign Application Priority Data
Jul. 15, 2022 (EP) 22382677.7

(51) Int. Cl. B29C 70/44; B29C 70/54

(52) U.S. Cl. CPC B29C 70/44; B29C 70/544

(57) ABSTRACT

A composite part manufacturing method comprising the following consecutive steps: providing a manufacturing tooling, providing a composite laminate on the manufacturing tooling, providing a release film covering the composite laminate, providing a breather fabric covering the release film, providing a vacuum bag film covering the composite laminate, the release film and the breather fabric, sealing the vacuum bag film to the manufacturing tooling, curing the composite laminate, unsealing the vacuum bag film from the manufacturing tooling, removing the vacuum bag film, removing the breather fabric, inspecting the breather fabric to detect resin residues, removing any detected resin residues from the breather fabric, transporting the removed breather fabric to a manufacturing process of another composite part.

### CROSS-REFERENCES TO RELATED APPLICATIONS

This application claims the benefit of the European patent application No. 22382677.7 filed on Jul. 15, 2022, the entire disclosures of which are incorporated herein by way of reference.

### FIELD OF THE INVENTION

The present invention is directed to the manufacture of a composite part. The manufacturing process comprises steps that allow a subsequent reuse of a breather fabric.

### BACKGROUND OF THE INVENTION

The composite material comprises plies that are usually of carbon or glass fiber. The composite plies are cured and the composite part is formed.

Vacuum bagging is a clamping method that uses atmospheric pressure to hold the laminate in place until the resin cures. The composite part is cured under temperature, pressure and vacuum conditions. The composite part is cured when the resin vitrifies beyond the glass transition point under certain conditions. Pressure, which can be up to several atmospheres, keeps the laminate in place but also affects the speed of the chemical reaction that occurs in the curing cycle of the part and helps to minimize the porosity of the part. Vacuum is an important parameter for curing the composite part, as it allows an evacuation of any air that may be trapped in the bag so that there are no pores/air inclusions in the laminate and also helps to maintain the position of the laminate.

A vacuum bagging for a composite part usually comprises the following elements:

A manufacturing tooling which is a mold on which the composite plies lie.
A vacuum bag film.
A sealing tape for sealing the vacuum bag film to the tooling.
A breather fabric, configured to avoid the risk of porosity in the cured material. The breather fabric facilitates aeration, i.e., breathing, during curing. The breather fabric covers, i.e., lays or spread over, the composite material and may be located directly over the composite material or over a release film, if included, or over any other sheet located between the breather fabric and the plies of composite material.
A release film, located in contact with the plies of composite material. The functions of the release film are to retain the resin during the curing process and to facilitate demolding and to protect the composite material from direct contact with the breather fabric.

Once the composite part has been cured, in an autoclave or in an oven, the vacuum bag film, the breather fabric and the release film are removed from the cured part, either manually or by automatic unwrapping, and normally discarded.

Reusable vacuum bag films are known. The reusable bags are specially made of materials such as silicone.

Currently, the breather fabric used in the curing of aircraft parts inside the vacuum bag film is not reused for manufacturing subsequent composite parts.

### SUMMARY OF THE INVENTION

It is an object of the invention a composite part manufacturing method wherein the manufacturing method comprises the following steps that are performed consecutively although they may have additional stages between two consecutive steps:
providing a manufacturing tooling,
providing a composite laminate on the manufacturing tooling,
providing a release film covering the composite laminate,
providing a breather fabric covering the release film, the breather fabric configured for facilitating aeration during a curing process,
providing a vacuum bag film covering the composite laminate, the release film and the breather fabric,
sealing the vacuum bag film to the manufacturing tooling,
curing the composite laminate, for instance, in an autoclave or oven,
unsealing the vacuum bag film from the manufacturing tooling,
removing the vacuum bag film,
removing the breather fabric, the breather fabric handling at this stage shall minimize the risk of contamination, preferably it can be done by automatic means or by assisted manual operation,
inspecting the breather fabric to detect resin residues,
if any, removing the resin residues from the breather fabric,
transporting the removed breather fabric to a manufacturing process of another composite part.

Therefore, at the end of the manufacturing process of a first composite part, the removed and cleaned of residues breather fabric is transported, i.e., transferred to another place in which another manufacturing process is or is going to be performed. In an embodiment, the removed breather fabric may be transported and stored, and the same manufacturing tooling may be prepared for another manufacturing process. In an embodiment, the removed breather fabric may be transported to another manufacturing tooling and immediately reused or being stored until it is reused.

The claimed invention allows a reuse of the breather fabric in subsequent manufacturing processes of composite parts. Advantages of the reuse of the breather fabric include the following:
Minimizing environmental impact through the reuse of auxiliary materials. For achieving this reuse, the breather fabric shall be handled properly, i.e., minimizing the risk of contamination and in turn allowing for the proper segregation of waste.
Cost savings by reusing materials.

The reused breather fabric could be applied in the manufacture of composite parts of any part of the aircraft. Preferably, the parts may have an irregular or uneven profile. Irregular profile means other than a flat surface and/or constant thickness, i.e., varying from the straight or parallel.

After the curing cycle, the breather fabric may have lost part of its aeration, breathing, capacity and flexibility, but as previously stated, it can be used in those composite parts having an uneven surface. In these composite parts not having a uniform thickness and/or not having a flat surface, the uneven surface generates a vacuum path that allows the reuse of a breather fabric may be having a lower aeration capacity.

Small resin residues may remain on the surface of the breather fabric due to breaks in the release film during or prior to curing. These areas, if any, with resin residues are removed, for instance, during storage of the material for reuse.

In an embodiment, it can be considered that the mentioned resin residues have to be removed only if they exceed a certain surface area. For instance, if the density is small, in the order of 1% or less of the surface of the breather fabric to be reused, the breather fabric is left as it is.

In a preferred embodiment, the manufacturing method minimizes the probability of contamination of the breather fabric, having a limited manual handling and providing automatic means.

### BRIEF DESCRIPTION OF THE DRAWINGS

To complete the description and to provide for a better understanding of the invention, a set of drawings is provided. The drawings form an integral part of the description and illustrate preferred embodiments of the invention. The drawings comprise the following figures.

FIG. 1 shows a schematic cross-section of a composite laminate located on a manufacturing tooling and the arrangement of the vacuum bagging.

FIG. 2 shows a perspective view of a vacuum bagging.

FIG. 3 shows an embodiment of the removal of the breather fabric.

FIG. 4 shows a schematic cross section of an embodiment of an irregular composite part and the arrangement of a reused breather fabric vacuum bagging process.

### DETAILED DESCRIPTION OF THE PREFERRED EMBODIMENTS

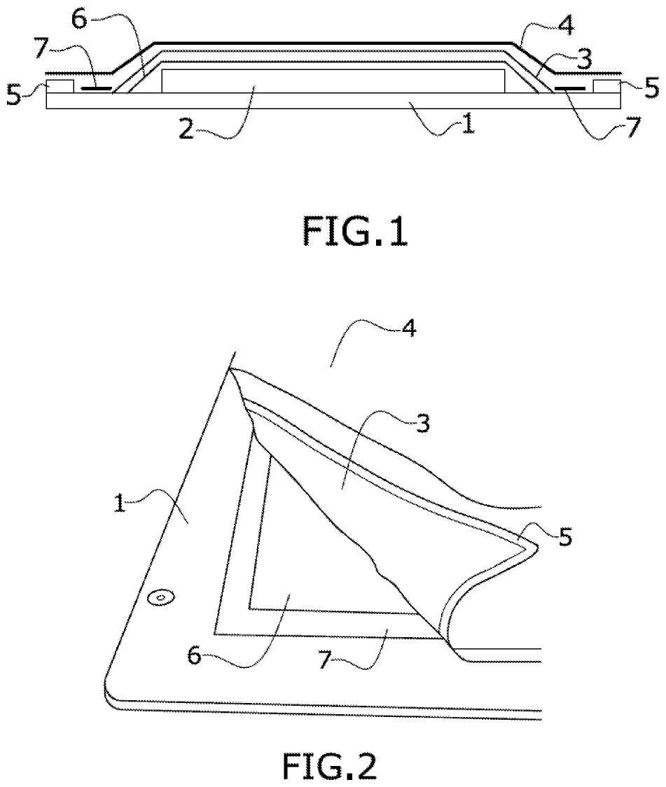

FIG. 1 discloses a vacuum bagging for a composite part, the following elements are disclosed:
a manufacturing tooling (1),
the composite laminate (2) placed on the manufacturing tooling (1),
the release film (6). More particularly, the release film (6) is located in contact with the plies of the composite laminate (2) and between the composite laminate (2) and the breather fabric (3),
the breather fabric (3) covering the release film (6),
the vacuum bag film (4) covering the composite laminate (2), the release film (6) and the breather fabric (3),
a sealing tape (5) sealing the vacuum bag film (4) to the manufacturing tooling (1),
an optional breather tape (7) located adjacent to the sealing tape (5) and covered by the vacuum bag film (4).

As previously stated, the manufacturing method object of the invention comprises the following consecutive steps:
providing a manufacturing tooling (1),
providing a composite laminate (2) on the manufacturing tooling (1),
providing a release film (6) covering the composite laminate (2),
providing a breather fabric (3) covering the release film (6),
providing a vacuum bag film (4) covering the composite laminate (2), the release film (6) and the breather fabric (3),
sealing the vacuum bag film (4) to the manufacturing tooling (1),
curing the composite laminate (2),
unsealing the vacuum bag film (4) from the manufacturing tooling (1),
removing the vacuum bag film (4),
removing the breather fabric (3),
inspecting the breather fabric (3) to detect resin residues,
if any, removing the resin residues from the breather fabric (3),
transporting the removed breather fabric (3) to a manufacturing process of another composite part.

In an embodiment, the composite part manufacturing method comprises the step of providing a sealing tape (5) for sealing the vacuum bag film (4) to the manufacturing tooling (1). Preferably, the sealing tape (5) is positioned onto the manufacturing tooling (1) before providing the release film (6).

The release film (6) may be removed after removing the breather fabric (3) or after inspecting the breather fabric (3) to detect resin residues or after removing the resin residues from the breather fabric (3) or, preferably, after transporting the removed breather fabric (3) to the manufacturing process of another composite part.

According to the above described, in an embodiment the stage in which the vacuum bagging is performed comprises the following steps:
providing a manufacturing tooling (1),
positioning a composite laminate (2) on the manufacturing tooling (1),
positioning the sealing tape (5) onto the manufacturing tooling (1),
positioning the release film (6) onto the composite laminate (2),
positioning the breather fabric (3) onto the release film (6) in order to facilitate aeration during the curing process,
positioning the vacuum bag film (4) covering the previous structure, i.e., the composite laminate (2), the release film (6) and breather fabric (3),
adhering the vacuum bag film (4) to the sealing tape (5) for the bag completion.

Afterwards, in an embodiment, a connection of vacuum intakes is done, and a vacuum leak test is performed to the above vacuum bagging structure. Finally, the complete set is load into an autoclave or oven and the composite part is cured.

After the curing stage, the vacuum bag film (4) is removed. In an embodiment, the following steps are performed:
disconnection of the vacuum from the intakes,
unloading of the above set from de autoclave or oven.
unsealing the vacuum bag film (4) from the sealing tape (5),
removing the vacuum bag film (4),
removing the breather fabric (3) handling the material minimizing the risk of contamination by automatic means or assisted manual operation,
inspecting the breather fabric (3) to detect resin residues,
if any, removing the resin residues from the breather fabric (3),
transporting the removed breather fabric (3) for the manufacturing process of another composite part,
removing the release film (6).

In an embodiment, if the area with resin residues is approximately 1% or less of the area of the removed breather fabric (3), the resin residues are not removed.

In an embodiment, to minimize the risk of contamination of the breather fabric (3) during the removal of the material from the cured part and to be able to reuse it (3), the removal of the vacuum bag film (4) is performed automatically. It could be done manually but with assisted support to guarantee the non-contamination of the material.

FIG. 2 discloses a perspective view of the arrangement of the different elements in a vacuum bagging. Specifically, the manufacturing tooling (1), the vacuum bag film (4), the breather fabric (3), the breather tape (7), the release film (6) and the sealing tape (5) are depicted.

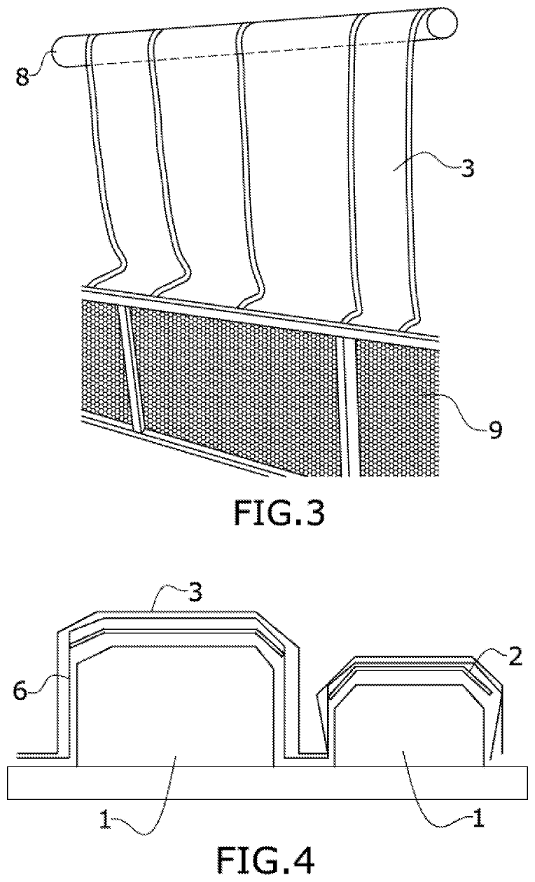

FIG. 3 discloses an embodiment for removing the breather fabric (3). The step of removing the breather fabric (3) is performed automatically or manually rolling the breather fabric (3). Afterwards, the removed breather fabric (3) may be unrolled before being reused.

In the shown embodiment, the removal is done by automatic winding on a roller (8) that may be attached to a gantry crane which in turn has a translational movement along, for instance, a cradle axis.

In the shown embodiment, the removed breather fabric (3) is stored before being reused, for instance, in a container (9). Thus, the removed breather fabric (3) is transported to a manufacturing process of another composite part and stored until it is reused in another manufacturing process. The removed breather fabric (3) can be used several times.

The vacuum bag film (4) may also be manually removed or automatically removed. On their part, the release film (6) is also removed after removing the breather fabric (3). The removal may also be done by automatic winding on the roller (8) that is attached to the gantry crane.

In an embodiment, the removed breather fabric (3) is cut to fit the subsequent composite part to be cured. The cutting step may be carried out when storing the breather fabric (3), if it is stored, or when removing it (3).

As previously stated, the composite part of the manufacturing process of another composite part comprises an uneven surface that may generate a vacuum path that allows the reuse of a breather fabric (3) although it may be has a lower aeration capacity.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A composite part manufacturing method comprising the following consecutive steps:
providing a manufacturing tooling,
providing a composite laminate on the manufacturing tooling,
providing a release film covering the composite laminate,
providing a breather fabric covering the release film, the breather fabric configured for facilitating aeration during a curing process,
providing a vacuum bag film covering the composite laminate, the release film and the breather fabric,
sealing the vacuum bag film to the manufacturing tooling,
curing the composite laminate,
unsealing the vacuum bag film from the manufacturing tooling,
removing the vacuum bag film,
removing the breather fabric,
inspecting the breather fabric to detect resin residues,
removing any detected resin residues from the breather fabric,
transporting the removed breather fabric to a manufacturing process of another composite part.

2. The composite part manufacturing method, according to claim 1, further comprising the step of providing a sealing tape for sealing the vacuum bag film to the manufacturing tooling.

3. The composite part manufacturing method, according to claim 2, wherein the sealing tape is positioned onto the manufacturing tooling before providing the release film.

4. The composite part manufacturing method, according to claim 1, wherein the release film is removed after transporting the removed breather fabric to the manufacturing process of another composite part.

5. The composite part manufacturing method, according to claim 1, wherein the step of removing the breather fabric is performed automatically or manually by rolling the breather fabric.

6. The composite part manufacturing method, according to claim 5, wherein the removed breather fabric is unrolled before manufacturing the another composite part.

7. The composite part manufacturing method, according to claim 5, wherein the step of removing the breather fabric is performed by automatic winding on a roller attached to a gantry crane having a translational movement along an axis.

8. The composite part manufacturing method, according to claim 1, wherein the removed breather fabric is stored before the another composite part is manufactured.

9. The composite part manufacturing method, according to claim 1, wherein the vacuum bag film is automatically removed.

10. The composite part manufacturing method, according to claim 1, wherein the composite laminate is cured in an autoclave or in an oven.

11. The composite part manufacturing method, according to claim 1, wherein if an area with resin residues is approximately 1% or less of the area of the removed breather fabric, the resin residues are not removed.

12. The composite part manufacturing method, according to claim 1, wherein the removed breather fabric is cut to fit the another composite part to be manufactured, the cutting step being carried out when storing or during the step of removing the breather fabric.

13. The composite part manufacturing method, according to claim 1, wherein the another composite part comprises an uneven surface.
